(19) United States
(12) Patent Application Publication
(10) Pub. No.: US 2026/0189161 A1
(43) Pub. Date: Jul. 2, 2026

(54) APPARATUS, SYSTEMS, AND METHODS OF EXTENDABLE MULTI-STAGE ENERGY HARVESTERS

(71) Applicant: Toyota Motor Engineering & Manufacturing North America, Inc., Plano, TX (US)

(72) Inventors: Tianzhu Fan, Houston, TX (US); Shailesh Joshi, Ann Arbor, MI (US); Yohei Iwahashi, South Lyion, MI (US); Feng Zhou, Ann Arbor, MI (US); Jae Seung Lee, Ann Arbor, MI (US); Tomoya Sugimoto, Frisco, TX (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/006,942

(22) Filed: Dec. 31, 2024

(51) Int. Cl. H02N 2/18

(52) U.S. Cl. CPC H02N 2/186

(57) ABSTRACT

A vibration energy harvest device includes two or more slidably coupled stages, each stage comprising a base end and an extended end, at least one stage comprising a piezoelectric unit comprising two electrode layers and a piezoelectric layer sandwiched by the two electrode layers, and wherein the stages are configured to slide against one or more neighbor stages to switch between an extended mode and a stacked mode.

### TECHNICAL FIELD

The present disclosure relates to apparatus, systems, and methods for energy conversion of ambient energy into electric energy, more specifically, to apparatus, systems, and methods for converting mechanical energy into electric energy using piezoelectric materials and components.

### BACKGROUND

Existing energy systems rely heavily on finite batteries and grid connections, leading to frequent maintenance, high costs, and environmental impacts such as battery waste and carbon emissions. Accordingly, there exists a need to utilize the ambient energy, especially for remote or inaccessible locations, to decrease the relying on vulnerable energy systems to disruptions from grid outages.

### SUMMARY

In one embodiment, a vibration energy harvest device includes two or more slidably coupled stages, each stage comprising a base end and an extended end, at least one stage comprising a piezoelectric unit comprising two electrode layers and a piezoelectric layer sandwiched by the two electrode layers, and wherein the stages are configured to slide against one or more neighbor stages to switch between an extended mode and a stacked mode.

In another embodiment, a vibration energy harvest system includes a base, two or more slidably coupled stages, an energy storage unit electrically coupled to the electrode layers, and a rectifier configured to convert an alternating voltage outputted from a piezoelectric unit into direct voltage. Each stage includes a base end and an extended end. At least one stage includes the piezoelectric unit including two electrode layers and a piezoelectric layer sandwiched by the two electrode layers. The stages are configured to slide against one or more neighbor stages to switch between an extended mode and a stacked mode. One or more of the base ends are mechanically coupled to the base.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a perspective view of an example extensible multi-stage energy harvester in an extended mode of the present disclosure, according to one or more embodiments shown and described herewith;

FIG. 2 schematically depicts a perspective view of an example extensible multi-stage energy harvester in a stacked mode of the present disclosure, according to one or more embodiments shown and described herewith;

FIG. 3 schematically depicts a perspective view of an example piezoelectric unit of the present disclosure, according to one or more embodiments shown and described herewith;

FIG. 4 schematically depicts a perspective view of connections of two example piezoelectric units of the present disclosure, according to one or more embodiments shown and described herewith;

FIG. 5 schematically depicts a front view of an example extensible multi-stage energy harvester including planar piezoelectric units of the present disclosure, according to one or more embodiments shown and described herein; and

FIG. 6 schematically depicts a front view of an example extensible multi-stage energy harvester including curved piezoelectric units of the present disclosure, according to one or more embodiments shown and described herein.

### DETAILED DESCRIPTION

This disclosure presents embodiments encompassing apparatuses, systems, and methods tailored for vibration energy harvesting utilizing piezoelectric materials and components. These apparatuses, systems, and methods of an extendable multi-stage energy harvester enable tuning the generated voltage, power, alternating current (AC) frequency, and efficiency of the vibration energy harvesting through changing the operation mode of the harvester, such as an extended mode and a stacked mode. The apparatuses and systems for energy harvesting include multiple stages, which may include one or more piezoelectric units. The multiple stages can be extended or stacked by sliding against the neighbor stages. In the extended mode, the apparatus and systems are more sensitive to ambient vibrations and provide a relatively high voltage, relatively high power, and relatively low AC frequency energy conversion. In the stacked mode, the apparatuses and the systems are less sensitive to ambient vibrations and provide a relatively low voltage, relatively low power, and relatively high AC frequency energy conversion. The disclosed systems may further include external circuits and grids to collect the generated electric energy.

Such an extendable, multi-stage piezoelectric energy harvester offers flexibility and efficiency for a wide range of applications. Its modular design allows for scalability, enabling users to add stages to capture more energy as needed. The dual mode of extending and stacking allows applicable usage of the apparatus and systems according to the ambient vibration. For example, the stackable nature of the harvester can reduce sensitivity to vibrations, preventing excessive deformation and wear of the piezoelectric materials, which in turn enhances the durability and longevity of the apparatus and systems. The dual mode features provide a consistent energy generation over time, for adaptive application under varying vibration conditions. Further, the disclosed apparatus and systems provide compactness to optimize space, making it suitable for applications where size is a concern, such as portable electronics, remote sensors, or industrial equipment. The ability to capture and repurpose otherwise wasted vibration energy promotes sustainability by reducing reliance on external power sources like the power grids, leading to lower maintenance costs and less environmental impact.

Further, the disclosed apparatuses, systems, and methods can be used in vehicle applications. When the vehicle is in motion, the harvester can be stacked to minimize physical interference, maintaining the vehicle's aerodynamics and not compromising its handling or stability. When the vehicle is stationary, the harvester can be extended to maximize energy harvesting from ambient vibrations, such as those generated by the vehicle's systems or external sources like road conditions. This dynamic deployment maximizes energy capture during downtime, such as at traffic stops or while parked, ensuring efficient use of energy. By being adaptable to the vehicle's operational conditions, the harvester provides a sustainable power source without interfering with the vehicle's primary functions, making it ideal for electric vehicles, trucks, or autonomous systems.

As used herein, the singular forms “a,” “an” and “the” include plural referents unless the context clearly dictates otherwise. Thus, for example, reference to “a” component includes aspects having two or more such components unless the context clearly indicates otherwise.

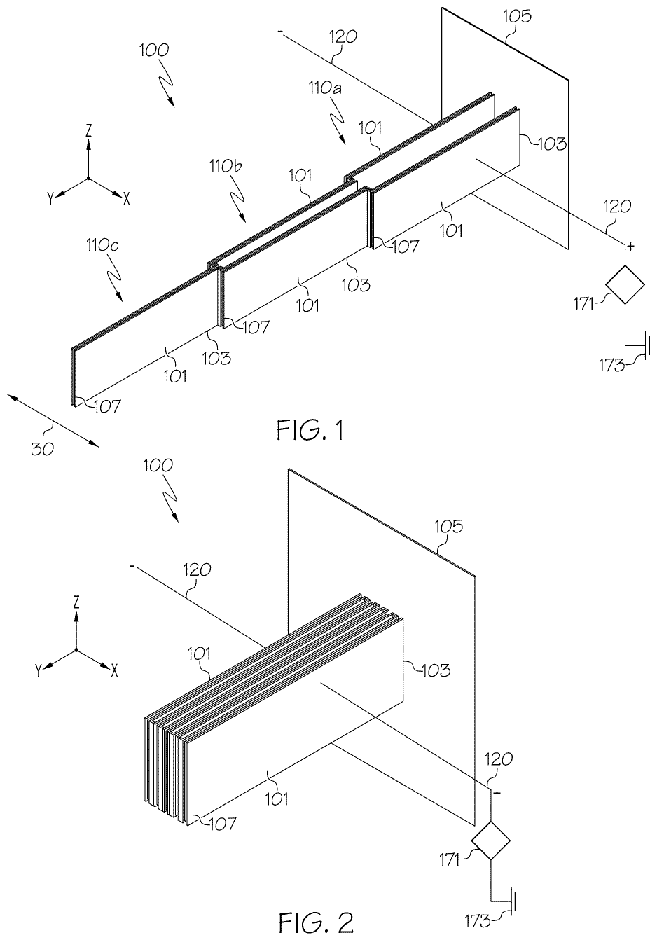

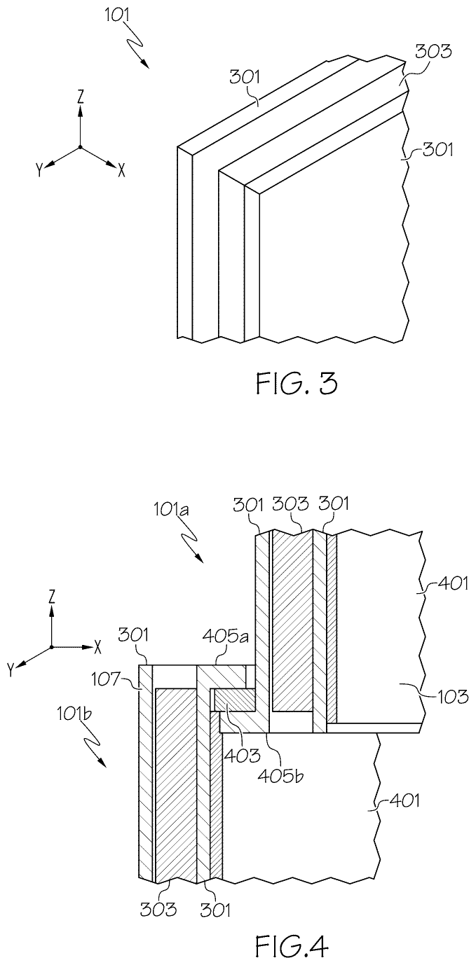

Referring now to figures, FIGS. 1-2 depict illustrative structures for an example vibration energy harvest device 100. The vibration energy harvest device 100 may include a base 105, two or more stages 110, such as, a first stage 110a, a second stage, and a third stage 110c as in FIGS. 1-2. Each stage 110 may include a base end 103 and an extended end 107. The base end may be the end closer to the base 105 and the extended end is the end to the direction of the extension direction, e.g., to the positive Y-axis direction. One or more of the stages 110 may include one or more piezoelectric units 101. The stages 110 may be slidably coupled to each other. For example, the piezoelectric unit 101 of the third stage 110c may be slidably coupled to the two neighbor piezoelectric units 101 of the second stage 110b. Each of the piezoelectric units of the second stage 110b may be slidably coupled to one of the two piezoelectric units 101 of the first stage 110a. the first stage 110a may be electrically coupled to an external circuit 120. As illustrated in FIG. 3, the piezoelectric unit may include two electrode layers 301 and a piezoelectric layer 303 sandwiched by the two electrode layers 301.

In some embodiments, at least one stage 110 of the stages 110 may include two piezoelectric units 101, for example, the two piezoelectric units 101 of the second stage 110b, and the two piezoelectric units 101 of the first stage 110a. In some embodiments, the stages 110 may include a central stage, for example, the third stage 110c. The central stage may include a central piezoelectric unit, for example, the piezoelectric unit 101 of the third stage 110c. The two piezoelectric units 110 of the first stage 110a and/or the second stage 110b may be symmetrically positioned on either side of the central stage, such as the third stage 110c.

In some embodiments, the stages 110 may be configured to slide against one or more neighbor stages 110 to switch between an extended mode (e.g., as in FIG. 1) and a stacked mode (e.g., as in FIG. 2). In some embodiments, the vibration energy harvest device 100 may include one or more actuators to move the stages 110 to alide against the neighbor stages 110. The actuators may include, without limitation, one or more of electric linear actuators, hydraulic actuators, pneumatic actuators, piezoelectric actuators, or other similar actuators configured to move the stages 110 to slide against the neighbor stages 110. The vibration energy harvest device 100 may include a controller to control the actuators to switch the modes between the stacked mode and the extended mode in accordance with the desired operation status, such as relatively high or low power, voltage, and/or alternating frequency, considering the ambient conditions, such as the vibration intensity and the charging status of the energy storage unit 173. In some embodiments, the stages 110 may be manually extended or stacked by a user. The stages may be moved In the extendable mode, the extended end 107 of one stage 110 may be close to the base end 103 of a neighbor stage 110. For example, as in FIG. 1, the extended end 107 of the second stage 110b may be next to the base end 103 of the third stage 110c. The base end 103 of the second stage 110b may be next to the extended end 107 of the first stage 110a. The base end 103 of the first stage 110a may be mechanically coupled to the base 105. In the stacked mode, all the base end 103 of the stages 110 may be next to the base 105. For example, as in FIG. 2, the base end 103 of the second stage 110b may be next to the base end 103 of the third stage 110c, the base end of the first stage 110a, and/or the base 105. The extended end 107 of the second stage 110b may be next to the extended end 107 of the first stage 110a and/or the extended end 107 of the third stage 110c.

In some embodiments, the first stage 110a may be electrically coupled to an external circuit 120. The external circuit 120 may include, without limitation, one or more energy storage units. The energy storage unit 173 may include a chargeable battery (e.g., a lithium-ion battery and a nickel-metal hydride battery), a supercapacitor, a solid-state battery, a flywheel energy storage device, and any energy storage devices suitable for the current application. The external circuit 120 may include a rectifier 171 configured to convert the alternating voltage outputted from the piezoelectric units 101 into direct voltage. The rectifier 171 may be a bridge rectifier including four diodes arranged in a bridge configuration. The rectifier 171 may further include a smoothing capacitor to match the generated direct voltage to charge the energy storage unit 173.

In operation, the stages 110 may deform due to ambient vibrations, such as mechanical movement of the base or airflow impacting the stage surfaces. The ambient vibrations may affect the piezoelectric units 101, causing bending (with compressive strain on one side and tensile strain on the other), stretching, or compressing. For example, the stages 110 may bend back and forward in the vibration direction 30. These mechanical strains may alter the relative positions of ions within the piezoelectric material of the piezoelectric layer 303, creating a net dipole moment that generates an electric field. As a result, positive and negative charges may accumulate on opposite surfaces of the piezoelectric layer 303, producing a voltage difference. The electrode layers 301 on the opposite surfaces of the piezoelectric layer 303 may capture the generated charges and transfer the charges to the external circuit 120. Due to alternating strain states (shifting between tensile and compressive strains) on the piezoelectric layer 303, the resulting voltage may alternate between positive and negative, creating an alternating voltage. The frequency of this alternating voltage may correspond to the vibration frequency. In some embodiments, when the vibration energy harvest device 100 operates in the extended mode (e.g., in FIG. 1), the vibration energy harvest device 100 may be more sensitive to ambient vibrations, undergoing greater deformation. Consequently, the generated alternating voltage and power output in the extended mode are higher compared to the stacked mode (e.g., as in FIG. 2). Conversely, in the stacked mode, the vibration energy harvest device 100 may be less sensitive to ambient vibrations, experience smaller deformation, and produce lower alternating voltage and power output compared to the extended mode.

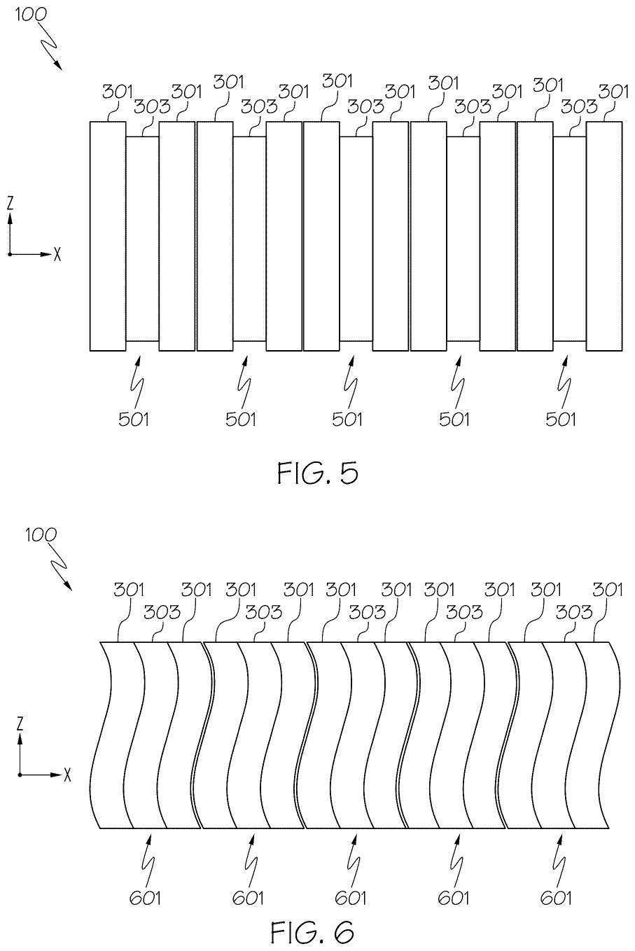

Referring to FIG. 3, the piezoelectric unit 101 may include the two electrode layers 301 and the piezoelectric layer 303 in between the two electrode layers 301. The piezoelectric layer 303 and the electrode layers 301 may be in planar shape (e.g., in FIG. 5) to have the piezoelectric unit 101 in the form of a cantilever beam. In some embodiments, the piezoelectric unit 101 may be, without limitation, in a triangular beam, S-shape beam, and/or cylindrical or conical structures. In some embodiments, the piezoelectric unit 101 may include multiple piezoelectric layers 303 and electrode layers 301, such as in a bimorph structure. In some embodiments, as in FIGS. 1-2, the piezoelectric unit 101 has a length in the extension direction (e.g., in the y-axis direction), a width (e.g., in the z-axis direction), and a thickness (e.g., in the x-axis direction). The piezoelectric layer 303 and the electrode layers 301 may be stacked in the thickness direction (e.g., the x-axis direction). The piezoelectric layer 303 may include piezoelectric materials and/or ferroelectric materials, such as, without limitation, quartz, lithium niobate, lead zirconate titanate, barium titanate, PVDF, PVDF-TrFE, lead magnesium niobate, or bismuth ferrite. The piezoelectric materials and/or the ferroelectric materials are flexible, allowing bending and strains in various directions. The piezoelectric layer 301 may include a polarization direction. In some embodiments, the polarization direction in the piezoelectric layer 301 may be in the out-of-plane direction (e.g., the x-axis direction). The piezoelectric layers 303 in different piezoelectric units 101 may be aligned in a substantially same direction, such as, in the positive x-axis direction, to maximize the electric energy collection of the out-of-plane direction. In some embodiments, the polarization directions of the piezoelectric layers 303 in different piezoelectric units 101 may be poled in different directions, for example, including both the out-of-plane direction (x-axis direction) and in-plane directions (any directions within the plane of y-axis and z-axis), to collect electric energy due to strain from various directions.

Referring to FIG. 4, the connection between the example piezoelectric units 101 is depicted. In some embodiments, one or more of the stages 110 may include one or more stop mechanisms 405 at one or both of the base end 103 and the extended end 107. The stop mechanism 405 may be configured to engage a neighbor stop mechanism 405 of one neighbor stage 110 when the piezoelectric units 101 slide against the neighbor piezoelectric units. For example, and the base end 103 of the piezoelectric unit 101a may include the stop mechanism 405a. The extended end 107 of the piezoelectric unit 101b may include the stop mechanism 405b. The stop mechanism 405a may be mechanically engaged with the stop mechanism 405b when the vibration energy harvest device 100 is in the extended mode. The stop mechanisms 405 may be, without limitation, one or more of a protrusion, a hook, a spring-loaded latch, a hook-like catch, a friction lock, a clutch, or a combination thereof. In embodiments, one of the electrode layers 301 of one stage 110 may be electrically coupled to one of the electrode layers 301 of a neighbor stage 110. In some embodiments, the electrode layer 301 may be electrically coupled through direct contact. In some embodiments, the electrode layer 301 may be electrically coupled through one or more conductive joints 403. For example, as in FIG. 4, the conductive joint 403 between the electrode layers 301 of the stages 110a and 110b may electrically connect the two electrode layers 301. The conductive joint 403 may be electrically and mechanically coupled to one stop mechanism 405 in the stacked mode and to two stop mechanisms 405 in the extended mode such that the piezoelectric units may be electrically disconnected in the stacked mode and electrically connected in the extended mode. In some embodiments, the conductive joint 403 may be configured to electrically couple one electrode layer 301 of the piezoelectric unit 101 with the external circuit 120.

In some embodiments, one or both electrode layers 301 of one stage 110 may be covered by a soft coating layer 401. The soft coating layer 401 may provide buffering to reduce the friction between the electrode layer 301 of one piezoelectric unit 101 and the electrode layer 301 of one neighbor piezoelectric unit 101 during the relative movement, such as switching between the extended mode and the stacked mode. The soft coating layer 401 may include, without limitation, low-friction metal oxide (e.g. alumina or zinc oxide), solid lubricants (e.g., graphite, graphene, or layered two-dimensional materials), polymers (e.g., Teflon, polyimides, polyether ether ketone), soft foam, rubber, or composites. The soft coating layer 401 may be conductive or resistive.

Referring to FIGS. 5 and 6, example vibration energy harvest devices 100 may include one or more of planar piezoelectric units 501 (as in FIG. 5) and/or curved piezoelectric units 601 (as in FIG. 6). As illustrated in FIG. 5, in some embodiments, the piezoelectric units 101 may be planar piezoelectric units 501. The planar piezoelectric unit 501 may include piezoelectric layer 303 sandwiched by two electrode layers 301. The piezoelectric layer 303 and the electrode layers 301 may be in planar shape such that the electrode layers 301 may cover planar surfaces of the piezoelectric layer 303 on both sides. In operation, the electrode layers 301 and the piezoelectric layer 303 may deform together according to the ambient vibration under a similar degree of strain.

As illustrated in FIG. 6, in some embodiments, one or more of the piezoelectric units 101 may be curved piezoelectric units 601. The piezoelectric layer 303 and the electrode layers 301 may be in similar curved shapes such that the electrode layers 301 may cover primary surfaces of the piezoelectric layer 303 on both sides. In operation, the electrode layers 301 and the piezoelectric layer 303 may deform together according to the ambient vibration under a similar degree of strain. The curved piezoelectric units 601 may be configured to generate an electric voltage in response to a strain in an in-planar direction (e.g., directions in the Y-Z plane), an out-of-planar direction (e.g., the X-axis direction), or both. The curved piezoelectric units 601 may have a curved geometry when viewed along the thickness direction (e.g., view in the X-Z plane). Accordingly, the curved piezoelectric unit 601 may generate electric voltage in response to strain along directions within the Y-Z plane such that the vibration energy harvest device 100 may include vibration sensitivity to forces or deformations parallel to the primary surface of the unit. Further, the curved piezoelectric unit 601 may generate an electric voltage in response to strain perpendicular to the primary plane of the curved piezoelectric unit 601. Accordingly, the vibration energy harvest device 100 can detect and generate a response and electric voltage for both in-plane and out-of-plane strains. The curved piezoelectric unit 601 can include different curved shapes in the thickness direction. For example, the curved piezoelectric unit 601 may be in a S-shape as in FIG. 6. The curved piezoelectric unit 601 may include one or more concave and convex regions from the side along the thickness direction. In some embodiments, the curved piezoelectric units 601 may include, without limitations, an arch or semi-circular cross-section, a wavy or sinusoidal shape cross-section, a dome-shaped or hemispherical cross-section, a spiral or helical shape cross-section, a parabolic or hyperbolic shape cross-section, or a ring-shape or donut-shape cross-section.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vibration energy harvest device comprising:
two or more slidably coupled stages, each stage comprising a base end and an extended end, at least one stage comprising a piezoelectric unit comprising two electrode layers and a piezoelectric layer sandwiched by the two electrode layers; and
wherein the stages are configured to slide against one or more neighbor stages to switch between an extended mode and a stacked mode.

2. The vibration energy harvest device of claim 1, wherein the piezoelectric unit is a curved piezoelectric unit.

3. The vibration energy harvest device of claim 2, wherein the curved piezoelectric unit is configured to generate an electric voltage in response to a strain in an in-planar direction, an out-of-planar direction, or both.

4. The vibration energy harvest device of claim 2, where the piezoelectric unit is in a S-shape.

5. The vibration energy harvest device of claim 1, wherein one or more of the stages further comprise one or more stop mechanisms at one or both of the base end and the extended end, the stop mechanism of one stage configured to engage a neighbor stop mechanism of one neighbor stage.

6. The vibration energy harvest device of claim 5, wherein the stop mechanisms are one or more of a protrusion, a hook, a spring-loaded latch, a hook-like catch, a friction lock, a clutch, or a combination thereof.

7. The vibration energy harvest device of claim 1, wherein one or more of the stages comprise one or more conductive joints configured to electrically couple one electrode layer of the piezoelectric unit with one neighbor stage, an external circuit, or both.

8. The vibration energy harvest device of claim 1, wherein the at least one stage of the stages comprises two piezoelectric units.

9. The vibration energy harvest device of claim 8, wherein the stages comprise a central stage, the central stage comprises a central piezoelectric unit, and the two piezoelectric units are symmetrically positioned on either side of the central stage.

10. The vibration energy harvest device of claim 1, wherein the stages comprise two or more piezoelectric units, and the piezoelectric units are electrically connected in series.

11. The vibration energy harvest device of claim 1, wherein the electrode layers are electrically coupled to an energy storage unit.

12. The vibration energy harvest device of claim 11, wherein the electrode layers are coupled to the energy storage unit through a rectifier, the rectifier configured to convert an alternating voltage outputted from the piezoelectric unit into direct voltage.

13. A vibration energy harvest system comprising:
a base;
two or more slidably coupled stages, each stage comprising a base end and an extended end, at least one stage comprising a piezoelectric unit comprising two electrode layers and a piezoelectric layer sandwiched by the two electrode layers;
an energy storage unit electrically coupled to the electrode layers; and
a rectifier configured to convert an alternating voltage outputted from the piezoelectric unit into direct voltage,
wherein:
the stages are configured to slide against one or more neighbor stages to switch between an extended mode and a stacked mode; and
one or more of the base ends are mechanically coupled to the base.

14. The vibration energy harvest system of claim 13, wherein the piezoelectric unit is a curved piezoelectric unit configured to generate an electric voltage in response to a strain in an in-planar direction, an out-of-planar direction, or both.

15. The vibration energy harvest system of claim 13, wherein one or more of the stages further comprise one or more stop mechanisms at one or both of the base end and the extended end, the stop mechanism of one stage configured to engage a neighbor stop mechanism of one neighbor stage.

16. The vibration energy harvest system of claim 15, wherein the stop mechanism is a protrusion, a hook, a spring-loaded latch, a hook-like catch, a friction lock, a clutch, or a combination thereof.

17. The vibration energy harvest system of claim 13, wherein one or more of the stages comprise one or more conductive joints configured to electrically couple one electrode layer of the piezoelectric unit with one neighbor stage, an external circuit, or both.

18. The vibration energy harvest system of claim 13, wherein the at least one stage of the stages comprises two piezoelectric units.

19. The vibration energy harvest system of claim 18, wherein the stages comprise a central stage, the central stage comprises a central piezoelectric unit, and the two piezoelectric units are symmetrically positioned on either side of the central stage.

20. The vibration energy harvest system of claim 13, wherein the stages comprise two or more piezoelectric units, and the piezoelectric units are electrically connected in series.
